(19) United States
(12) Patent Application Publication
(10) Pub. No.: US 2011/0122064 A1
(43) Pub. Date: May 26, 2011

(54) Anti-gravity Mouse

(76) Inventor: Xiaoming Deng, Flushing, NY (US)

(21) Appl. No.: 12/623,429

(22) Filed: Nov. 22, 2009

(51) Int. Cl. G06F 3/033

(52) U.S. Cl. 345/163

(57) ABSTRACT

A hand-held computer mouse for controlling a graphical pointer on a computer display characterized by incorporating permanent magnet or electromagnet to repel a magnetic surface to reduce or eliminate friction during usage, thereby making the pointer manipulating device sensitive to the slightest movement of a hand, and thinning the barrier between mind and physical world.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### BACKGROUND OF THE INVENTION

### Field of Invention

The present invention relates to a hand-held computer mouse that incorporate magnet to simulate anti-gravity to reduce or eliminate friction when move on a magnetic surface.

### Prior Art

One of the hot items in today's consumer market is high performance infrared, laser, or optical gaming mouse. They all have one commonality of requiring user to move its full weight on a flat surface. However, the force require a user to overcome the friction with the flat surface in order to initiate the movement of a mouse undermines the accuracy and the speed of pointer placement according to the user's intension. Such a problem is prevalence and appearance to gamers of high quality first person shooting personal computer (PC) games that requires gamer to move a cross-hair from point A to point B accurately in shortest possible time. Upon moved the mouse, the gamer often required to re-adjust the direction of the cross-hair movement as often as necessary and as much as 180 degrees in order to make the necessary pointer correction.

I conclude that the frequency of pointer correction is related to the friction of the mouse with a flat surface, therefore reduce or eliminate the friction with a flat surface will reduce the frequency of pointer correction.

### Objects and Advantages

My invention will connect user's mind and physical world closer than aforementioned prior art mouse by simulating the effect of anti-gravity on a mouse to reduce or eliminate the friction on a flat surface during usage, thereby making the hand-held device sensitive to the slightest movement of a hand. As result, my invention will have a competitive advantage over aforementioned high performance gaming mouse in time sensitive pointer manipulating application such as high quality first person shooting PC games.

### SUMMARY

The object of my invention is to push today's high performance optical gaming mouse into a higher level of performance by incorporate magnetism to simulate anti-gravity on a mouse to reduce or eliminate friction on a magnetic surface during usage, thereby making the pointer manipulating device sensitive to the slightest movement of a hand.

### DRAWING—FIGURES

FIG. 1, side view of magnetic mouse 23 on magnetic surface 25 or magnetic mouse pad

### REFERENCE NUMERALS

23, magnetic mouse
24, magnetic portion of the mouse using a line of N and a line of S to represent North pole and South pole
25, magnetic surface or magnetic mouse pad using a line of N and a line of S to represent North pole and South pole

### DETAILED DESCRIPTION

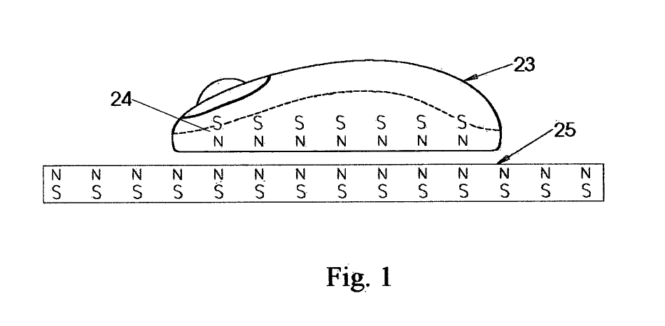

### FIG. 1—PREFERRED EMBODIMENT

This invention incorporates magnet on a computer mouse 23 to repel a magnetic surface 25 to reduce or eliminate friction with said magnetic surface during usage. The magnetic portion 24 of mouse 23 can be one piece or multiple pieces of magnet that can be in many different shapes and sizes. In the drawing symbolically represented by a line of “S” as the South Pole and a line of “N” as the North Pole distributed evenly at the base of mouse 23. The case of the mouse can be made from injection molded magnet.

Magnetic portion 24 can be permanent magnet(s) or electromagnet(s). If said magnetic portion is permanent magnet(s), mouse 23 can be designed so that weight can easily add or reduce by user according his or her preference. Also, magnets that near the side of the mouse can have their North Pole and South Pole oriented slightly off perpendicular with magnetic surface 25 so as to reduce the chance of the mouse from tipping over.

If said magnetic portion is electromagnet, the repulsive force of the magnet can easily be adjusted by providing a control for user to control the amount of current that pass through a coil of wire within the mouse.

The force of the magnet that repel between the mouse and the magnetic mouse pad can be anywhere from about 90 percent to as much as 200 percent of the mouse's weight, depending on how a designer target user's preference. My personal preference is to have the repulsive force of the magnet approximately equal to the weight of the mouse plus the weight of my hand that rest on the mouse plus the weight that required to make a left click or a right click, so when I clicked the mouse, the mouse will make contact with a magnetic surface, and any additional movement will be met with friction with a magnetic mouse pad.

Examples of magnetic surface 25 or magnetic mouse pad is a sheet of rectangular, or square, or circular permanent magnet magnetized through thickness, having North Pole on one side and South Pole on the other side, preferably cover with protective layer for surface protection and/or breakage prevention. The material for said permanent magnet can be ceramic magnet or other rare earth magnet or rubber base flexible magnet. Said protective layer can be ABS plastic or aluminum alloy that encase the hard magnet for shock protection, and for flexible magnet, polyvinyl chloride is added on top as cover.

I claim:

1. A hand-held device for controlling a graphical pointer on a computer display characterized by using magnet to repel a magnetic surface to reduce or eliminate friction during usage.

2. The hand-held device of claim 1 wherein said magnet is permanent magnet.

3. The hand-held device of claim 1 wherein said magnet is electromagnet.
